(19) United States
(12) Patent Application Publication
(10) Pub. No.: US 2021/0212364 A1
(43) Pub. Date: Jul. 15, 2021

(54) ARTICLE FOR FORMING AN AEROSOL

(71) Applicant: PHILIP MORRIS PRODUCTS S.A., Neuchatel (CH)

(72) Inventors: Rui Nuno Batista, Morges (CH); Frederic Nicolas, Moret-Loing-et-Orvanne (FR); Cyrille Poindron, Cruseilles (FR)

(21) Appl. No.: 17/262,317

(22) PCT Filed: Jul. 18, 2019
(86) PCT No.: PCT/EP2019/069410

§ 371 Date: Jan. 22, 2021

(30) Foreign Application Priority Data
Jul. 26, 2018 (EP) 18185900.0

(51) Int. Cl. A24F 40/20; A24F 40/46; A24B 15/22

(52) U.S. Cl. CPC A24F 40/20; A24B 15/22; A24F 40/46

(57) ABSTRACT

An article (1) for forming an aerosol. The article (1) comprise an aerosol-forming substrate (2) and a first major surface (1a) which is substantially flat. The aerosol-forming substrate (2) comprises a first region (20) having a first density and second region (21) having a second density. The first density is different to the second density. The article (1) is insertable into the heating chamber of a device for generating an aerosol.

This invention relates generally to an article for forming an aerosol and to a method of use thereof.

Devices for generating aerosols which heat rather than combust an aerosol-forming substrate have previously been proposed in the art. For example, heated smoking devices in which tobacco is heated rather than combusted, have been proposed. One aim of such smoking devices is to reduce the generation of unwanted and harmful smoke constituents of the type produced by the combustion and pyrolytic degradation of tobacco in conventional cigarettes. These heated smoking devices are commonly known as ‘heat not burn’ devices.

Heated smoking devices of the above-described type commonly comprise a heating chamber, provided with, e.g. defined by, heating surfaces, into which an article for forming an aerosol is inserted, prior to use. The article for forming an aerosol typically contains an aerosol-forming substrate which is subsequently heated by a heater of the device to generate an aerosol. In this way, when the aerosol-forming substrate contained in an article has been exhausted the article can be replaced, with the heated smoking device thereby constituting a reusable device whilst the article comprises a ‘consumable’ product. The articles for forming an aerosol are normally shaped and sized to mimic conventional cigarettes. Accordingly, the articles, and the heating chamber in the heated smoking device into which they are inserted or insertable, have a generally cylindrical shape. Typically, the diameter of the articles is from 5 to 10 mm, say about 7.2 mm.

Articles for forming an aerosol of the above-described type typically have a wrapper or carrier layer within which the aerosol-forming substrate is retained. Filter material is generally provided at one or both of the ends of the article, serving as a plug to retain the aerosol-forming substrate within the article and, also, to filter aerosol generated by the heated smoking device, in use. Additionally, an aerosol-cooling element (which may be formed from a gathered sheet of polylactic acid, for example) may be located within the article, between the aerosol-forming substrate and the filter at one end of the article. A support element (for example formed from a hollow acetate tube) may additionally be positioned between the aerosol-forming substrate and the aerosol-cooling element.

In use, a user inserts an article between the heating surfaces of the heating chamber of a heated smoking device. The user then draws air through a free end of the article (said free end comprising filter material). The heater within the heated smoking device is activated to transfer thermal energy to the article for forming an aerosol, thereby releasing volatile compounds from the aerosol-forming substrate. Air is drawn into the heated smoking device by the user drawing on the article for forming an aerosol. The air flows through at least part of the device and then into and along the at least part of the length of the article, passing through the aerosol-forming substrate and drawing released volatile compounds therefrom along with it. The air flow and volatile compound mixture then passes through the cooling segment, where the volatile compounds cool and condense into an aerosol. This aerosol then passes through the filter material before being drawn into the lungs of the user. The wrapper or carrier layer acts as a baffle during this process and serves to direct the air flow causing it to flow through and along the article to the user.

Heating an aerosol-forming substrate, rather than combusting it, requires that the aerosol-forming substrate is heated to a relatively reduced temperature. Accordingly, a relatively reduced quantity of thermal energy need be transferred to the aerosol-forming substrate. The energy saved beneficially reduces the expense of operating the heated smoking device. Nevertheless, it would be beneficial to yet further reduce the quantity of thermal energy required to volatilize compounds from an article for forming an aerosol.

Furthermore, heating rather than combusting an aerosol-forming substrate may result in a more efficient use of the substrate, thereby requiring relatively reduced quantities of it, with consequential cost savings. However, in prior art articles for ‘heat not burn’ devices a portion of the aerosol-forming substrate may remain un-volatilized after use, thereby representing a waste of materials.

It would be desirable to provide an article for forming an aerosol which is improved over prior art articles for forming an aerosol. It would be desirable to provide an article for forming an aerosol which mitigates one or more of the above-identified issues. It would be desirable to provide an article for forming an aerosol which requires a relatively reduced quantity of thermal energy when heated in the heating chamber of a device for generating an aerosol. It would be desirable to provide an article for forming an aerosol in which a relatively reduced portion of aerosol-forming substrate thereof is not volatilized after heating thereof in a device for generating an aerosol. It would also be desirable to provide an article for forming an aerosol in which volatile compounds released from the aerosol-forming substrate may be extracted more readily and/or efficiently from the article. It would also be desirable to provide a method of using a device with one or more of the above-identified advantages.

According to an aspect of the invention, there is provided an article for forming an aerosol, the article comprising an aerosol-forming substrate and a first major surface which is substantially flat, the aerosol-forming substrate formed from an aerosol-forming material comprising a first region having a first density and a second region having a second density, where the first density is different to the second density, the article being insertable into the heating chamber of a device for generating an aerosol.

Advantageously, provision of aerosol-forming substrate having regions of different densities allows the aerosol-forming substrate to be tailored to specific requirements. For example, transfer of thermal energy into the article, extraction of volatile compounds from the article, resistance to draw of the article may be configured by selective location, sizing and relative density of the regions of different densities. Accordingly, articles for forming an aerosol having different properties and/or configured to respond differently to similar heating conditions in a heating chamber of a device for generating an aerosol may be readily and easily provided. Provision of a first major surface which is substantially flat, provides an increased surface area to volume ratio relative to prior art articles, which are typically cylindrical (as explained above). Accordingly, thermal energy may be transmitted more readily and efficiently into the article, in use, whilst volatile compounds may be extracted more readily therefrom, also. Articles according to the invention therefore provide highly customisable articles with enhanced efficiency of thermal transfer thereinto and volatile compounds therefrom.

As used herein, the phrase ‘aerosol-forming substrate’ is used to describe a substrate capable of releasing upon heating volatile compounds, which can form an aerosol. The aerosol generated from aerosol-forming substrates described herein may be visible or invisible to the human eye. The aerosol-forming substrate may comprise a solid, a fluid or a mixture of solid and fluid substrate. Where the aerosol-forming substrate is a fluid it is advantageously retained within a matrix and/or by a cover layer, at least prior to receipt of the aerosol-forming substrate in the heating chamber.

As used herein, the term ‘aerosol’ is used to describe a suspension of relatively small particles in a fluid medium.

In some embodiments, the article may have or comprise a second major surface, for example which is substantially flat. The first and second major surfaces may be substantially parallel to one another, for example may extend in generally parallel relations. The first and second major surfaces may be spaced from one another by less than 5 mm, say less than 4 mm, for example less than 3 mm. The article may have a generally parallelepiped shape. In embodiments, the article may comprise an upstream end and/or a downstream end. The article may be configured or arranged such that flow, in use, of fluid through the article travels from the upstream end to the downstream end. A cylinder has a relatively lower surface area to volume ratio than does a parallelepiped, for a given volume. Additionally, for a given volume and length, a cylinder has a relatively smaller cross-sectional area than does a parallelepiped. The resistance to draw (RTD) of a cylinder (for example a cylindrical object comprising aerosol forming substrate) is a well-known and important parameter for its use, for example when a user is inhaling therefrom.

The article may have a width, a length and/or a thickness, for example where the width, length and/or thickness are measured in a direction perpendicular to one another. The thickness may comprise the distance between the first and second major surfaces, where provided. The width and/or length of the article may have a ratio to the thickness of at least 2:1, for example at least 3:1, 4:1, 5:1, 6:1, 7:1, 8:1, 9:1 or 10:1. The width and/or the length of the article may be between approximately 2 mm and 120 mm, for example between approximately 3, 4, 5, 6, 7, 8, 9, 10 and 11, 12 , 13, 14, 15, 16, 17, 18, 19, 20, 25, 30, 35, 40, 45, 50, 55, 60, 65, 70, 75, 80, 85, 90, 95, 100, 105, 110, 115, 120 mm. The thickness of the article may be between approximately 0.5 mm and 15 mm, for example between approximately 0.5 or 1.0 mm and 1.5, 2.0, 2.5, 3.0, 3.5, 4.0, 4.5, 5.0, 6.0, 7.0, 8.0, 9.0, 10.0, 11.0 or 12.0 mm.

As used herein, the term ‘length’ is used to describe the maximum dimension in the longitudinal direction of the article for forming an aerosol. As used herein, the term ‘longitudinal’ is used to describe the direction between ends (e.g. upstream and downstream ends) of the article for forming an aerosol and the term ‘transverse’ is used to describe the direction perpendicular to the longitudinal direction. As used herein, the terms ‘upstream’ and ‘downstream’ are used to describe the relative positions of elements, or portions of elements, of the article for forming an aerosol in relation to the direction in which a user draws fluid through the article during use thereof.

Preferably, the aerosol-forming substrate comprises nicotine. The aerosol-forming substrate may comprise tobacco. Alternatively or in addition, the aerosol-forming substrate may comprise a non-tobacco containing aerosol-forming material.

If the aerosol-forming substrate is a solid aerosol-forming substrate, the solid aerosol- forming substrate may comprise, for example, one or more of: powder, granules, pellets, shreds, strands, strips or sheets (e.g. containing one or more of: herb leaf, tobacco leaf, tobacco ribs, expanded tobacco and homogenised tobacco).

Optionally, the solid aerosol-forming substrate may contain tobacco or non-tobacco volatile flavour compounds, which are released upon heating of the solid aerosol-forming substrate.

If the aerosol-forming substrate is in the form of a fluid, for example a liquid or a gas, the aerosol-forming substrate may contain tobacco or non-tobacco volatile flavour compounds, which are released upon heating of the fluid aerosol-forming substrate.

Optionally, the solid or fluid aerosol-forming substrate may be provided on or embedded in a carrier material, for example a thermally stable carrier material. The carrier material may take the form of a foam, e.g. an open or closed cell foam. The solid or fluid aerosol-forming substrate may be deposited throughout the carrier material, e.g. throughout the volume thereof. Additionally or alternatively, the solid or fluid aerosol-forming substrate may be deposited on the surface of the carrier material in the form of, for example, a sheet, foam, gel or slurry. The solid or fluid aerosol-forming substrate may be deposited on the entire surface of the carrier material, or alternatively, may be deposited in a pattern in order to provide a non-uniform flavour delivery during use.

In some embodiments, the article (for example the aerosol-forming substrate) may comprise a foam. The foam may be open celled or closed celled. The foam may be a reticulated open celled foam. The foam may be at least partially formed from tobacco, for example from reconstituted tobacco (e.g. stems and the like).

In some embodiments, the first region may have a first density which is greater than or less than the second density of the second region. The first region may comprise or have a greater, lesser or equal volume than does the second region. The first region may be at least partially surrounded by the second region. The first region may be at or adjacent one or more peripheral zones of the article. The first region may be sandwiched by the second region. The first and second regions may directly abut one another. Alternatively, the first region may be at least partially spaced from the second region. A buffer or spacer region may be provided between the first and second regions.

In some embodiments, the first and second regions may be affixed to one another. Alternatively, the first and second regions may be movable relative to one another.

In some embodiments, the first region may be formed from a different aerosol-forming substrate and/or may comprise a different structure than does the second region.

For example, one of the first and second regions may comprise solid aerosol-forming substrate and the other of the first and second regions may comprise a fluid (e.g. liquid or gaseous) aerosol-forming substrate. Additionally or alternatively, the first and second regions may comprise aerosol-forming substrate formed of or comprising different materials, different combinations of materials or different relative proportions of materials.

In some embodiments, the article may comprise one or more metal elements (for example susceptors). The, one, some or each of the one or more metal elements may be located in and/or on the article (for example the aerosol-forming substrate). The, one, some or each of the one or more metal elements may be located in and/or on the first and/or second region of the aerosol-forming substrate. Said one or more metal elements may extend at least partially along the length of the article. Said one or more metal elements may extend across at least partially across the width of the article. Said one or more metal elements may extend through the thickness of the article. Said one or more metal elements may have any suitable shape, for example: a loop, a coil, a strip, a sphere, a strand, a particle, irregular shaped and the like. Said one or more metal elements may comprise a metallic shell or cover layer of any suitable shape (for example as described above) surrounding a non-metallic material and/or which may be hollow. The one or more metal elements, where provided, are distinct from (e.g. do not comprise) aerosol-forming substrate

In some embodiments, the article may comprise a cover layer and/or wrapper. The cover layer and/or wrapper may extend about the external surfaces of the article, for example may circumscribe the periphery of the aerosol-forming substrate. The cover layer may be formed from a polymer such as a food grade plastic and/or a paper such as filter paper. Additionally or alternatively, the cover layer may comprise any other suitable material, for example abaca fibres and the like. The cover layer may comprise cellulose. The cover layer may comprise and/or be at least partially formed from tobacco, for example reconstituted tobacco. The cover layer may comprise plural apertures through its thickness, for example where the plural apertures may be arranged uniformly or randomly. The cover layer may comprise a net or mesh or weave. Alternatively, the cover layer may comprise a solid surface, for example having a region (e.g. a major region) absent plural apertures through its thickness.

Preferably, the aerosol-forming substrate comprises an aerosol former.

As used herein, the term ‘aerosol former’ is used to describe any suitable known compound or mixture of compounds that, in use, facilitates formation of an aerosol and that is substantially resistant to thermal degradation at the operating temperature of the aerosol-forming substrate. Suitable aerosol formers are known in the art and include, but are not limited to: polyhydric alcohols, such as propylene glycol, triethylene glycol, 1 ,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate

Preferred aerosol formers are polyhydric alcohols or mixtures thereof, such as propylene glycol, triethylene glycol, 1 ,3-butanediol and, most preferred, glycerine.

The aerosol-forming substrate may comprise a single aerosol former. Alternatively, the aerosol-forming substrate may comprise a combination of two or more aerosol formers.

Preferably, the aerosol-forming substrate has an aerosol former content of greater than 5% on a dry weight basis.

The aerosol aerosol-forming substrate may have an aerosol former content of between approximately 5% and approximately 30% on a dry weight basis.

In a preferred embodiment, the aerosol-forming substrate has an aerosol former content of approximately 20% on a dry weight basis.

The article for forming an aerosol may comprise a volatile flavour-generating component. The aerosol forming substrate (for example and/or the carrier material, where provided) may comprise the volatile flavour-generating component. The volatile flavour-generating component may be at least partially retained in and/or impregnated into and/or located on the surface of the aerosol-forming substrate and/or a carrier material (if such is provided) and/or the cover layer (where provided) and/or the peripheral mould surface thereof.

As used herein the term ‘volatile flavour-generating component’ is used to describe any volatile component that is added to an aerosol-forming substrate (for example and/or carrier material, where provided) in order to provide a flavourant.

Suitable flavourants include, but are not limited to, materials that contain natural or synthetic menthol, peppermint, spearmint, coffee, tea, spices (such as cinnamon, clove and ginger), cocoa, vanilla, fruit flavours, chocolate, eucalyptus, geranium, eugenol, agave, juniper, anethole, linalool, and the like.

As used herein, the term ‘menthol’ is used to describe the compound 2-isopropyl-5-methylcyclohexanol in any of its isomeric forms.

Menthol may be used in solid or liquid form. In solid form, menthol may be provided as particles or granules. The term ‘solid menthol particles’ may be used to describe any granular or particulate solid material comprising at least approximately 80% menthol by weight.

In some embodiments, the article for forming an aerosol (e.g. the aerosol-forming substrate) may be free of menthol.

Preferably, 1.5 mg or more of the volatile flavour-generating component is included in the aerosol-forming substrate.

The volatile flavour-generating component (where provided) may be in the form of a liquid or a solid. The volatile flavour-generating component may be coupled to, or otherwise associated with, a support element. The support element may comprise any suitable substrate or support for locating, holding, or retaining the volatile flavour-generating component. For example, the support element may comprise a fibrous support element, which may be saturated or saturatable with fluid, for example a liquid.

In embodiments, the volatile flavour-generating component may have any suitable structure in which a structural material releasably encloses a flavourant or flavourants. For example, in some preferred embodiments, the volatile flavour-generating component comprises a matrix structure defining a plurality of domains, the flavourant being trapped within the domains until released, for example, when the aerosol-forming substrate is subject to external force. Alternatively, the volatile flavour-generating component may comprise a capsule. Preferably, the capsule comprises an outer shell and an inner core containing the flavourant. Preferably, the outer shell is sealed before the application of an external force, but is frangible or breakable to allow the flavourant to be released when the external force is applied. The capsule may be formed in a variety of physical formations including, but not limited to, a single-part capsule, a multi-part capsule, a single-walled capsule, a multi-walled capsule, a large capsule, and a small capsule.

If the volatile flavour-generating component comprises a matrix structure defining a plurality of domains enclosing the flavourant, the flavourant delivery member may release the flavourant steadily when the aerosol-forming substrate is subject to external force.

Alternatively, if the volatile flavour-generating component is a capsule arranged to rupture or burst to release the flavourant when the article for forming an aerosol is subject to external force (for example, but not limited to, if the capsule comprises an outer shell and an inner core), the capsule may have any desired burst strength. The burst strength is the force (exerted on the capsule from the outside of the aerosol-forming substrate) at which the capsule will burst. The burst strength may be a peak in the capsule's force versus compression curve.

The volatile flavour-generating component may be configured to release the flavourant in response to an activation mechanism. Such an activation mechanism may include the application of a force to the volatile flavour-generating component, a change in temperature in the volatile flavour-generating component, a chemical reaction, or any combination thereof.

Resistance to draw (RTD), also known as draft resistance, draw resistance, puff resistance or puffability, is the pressure required to force air through the full length of the object under test at the rate of 17.5 ml/sec at 22° C. and 760 Torr (101 kPa). It is typically expressed in units of mmH2O and is measured in accordance with ISO 6565:2011. The resistance to draw (RTD) of the article for forming an aerosol (when inserted into a heating chamber of a device for generating an aerosol) may be between approximately 80 mmWG and approximately 140 mmWG. This approximates the RTD of a conventional cigarette. According to an aspect of the invention, there is provided a device for generating an aerosol, the device comprising a heating chamber for receiving an article for forming an aerosol and a heater, the heating chamber having (e.g. being at least partially defined by) first and second major boundary (e.g. heating) surfaces, where the heater is arranged or configured to effect heating, in use, of the heating chamber from each of the major boundary surfaces.

In some embodiments, the heater may be configured or arranged to heat via radiation, convection and/or conduction (for example the heater may be a radiation, convection and/or conduction heater). The heater may be configured or arranged to heat the first and/or second major boundary surface. The heater may comprise one or more inductive coils. The heater may comprise a heating element. The heater may comprise a fuel source, for example a fuel. The heater may be a resistive heater.

The first and second major boundary surfaces may be substantially flat. The first and second major boundary surfaces may be substantially parallel, for example may extend substantially parallel to one another. The first and second major boundary surfaces may be arranged or configured to at least partially define a principal flow path for fluid (e.g. gas, for example air) along and/or through the heating chamber.

According to an aspect of the invention, there is provided a combination of the device for generating an aerosol as described herein and an article for forming an aerosol as formed herein.

According to an aspect of the invention, there is provided a device for generating an aerosol in combination with an article for forming an aerosol as described herein, the device comprising a heating chamber for receiving an article for forming an aerosol and a heater, wherein:

either the heating chamber has (e.g. is at least partially defined by) first and second major boundary (e.g. heating) surfaces, and the heater is arranged or configured to effect heating, in use, of the heating chamber from each of the major boundary surfaces, the article for forming an aerosol being received or receivable in the heating chamber;

or the article for forming an aerosol comprises first and second major surfaces (for example one or both of which is substantially flat), and the heater is arranged or configured to heat (e.g. or to effect heating of), in use and when the article is received in the heating chamber, the article for forming an aerosol in a first direction substantially perpendicular to the first major surface and a second direction substantially perpendicular to the second major surface.

The heater may be configured or arranged to heat, in use, a central region or portion of the heating chamber and/or of an or the article for forming an aerosol received therein.

According to an aspect of the invention, there is provided a method of using an article for forming an aerosol, the method comprising:
a) providing an article for forming an aerosol comprising an aerosol-forming substrate and having a first major surface which is substantially flat, the aerosol-forming substrate comprising a first region having a first density and a second region having a second density, the first density being different to the second density;
b) inserting the article into a heating chamber of a device for generating an aerosol;
c) irradiating the article in the heating chamber with electromagnetic radiation to heat the aerosol-forming substrate and generate aerosol therefrom; and
d) flowing air through the aerosol-forming substrate.

In some embodiments, step c) may comprise irradiating the article with infra-red radiation, for example to heat the article. In some embodiments, step c) may comprise irradiating the article with a magnetic field, for example to induce heating in a metallic element (e.g. a susceptor) of the article.

In some embodiments, step d) may comprise drawing air through the aerosol-forming substrate, for example a user drawing air through the aerosol-forming substrate (e.g.

by drawing on a mouthpiece end of the device and/or by drawing on a portion of the article).

All scientific and technical terms used herein have meanings commonly used in the art unless otherwise specified. The definitions provided herein are to facilitate understanding of certain terms used frequently herein.

Throughout the description and claims of this specification, the words “comprise” and “comprising” and variations of them mean “including but not limited to”, and they are not intended to (and do not) exclude other moieties, additives, components, integers or steps. Throughout the description and claims of this specification, the singular encompasses the plural, and vice versa, unless the context otherwise requires. In particular, where the indefinite article is used, the specification is to be understood as contemplating plurality as well as singularity, unless the context requires otherwise.

For the avoidance of doubt, any of the features described herein apply equally to any aspect of the invention. Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one aspect or embodiment of the invention are applicable to all aspects or embodiments, unless such features are incompatible.

The invention will now be further described, by way of example only, with reference to the accompanying drawings, in which:

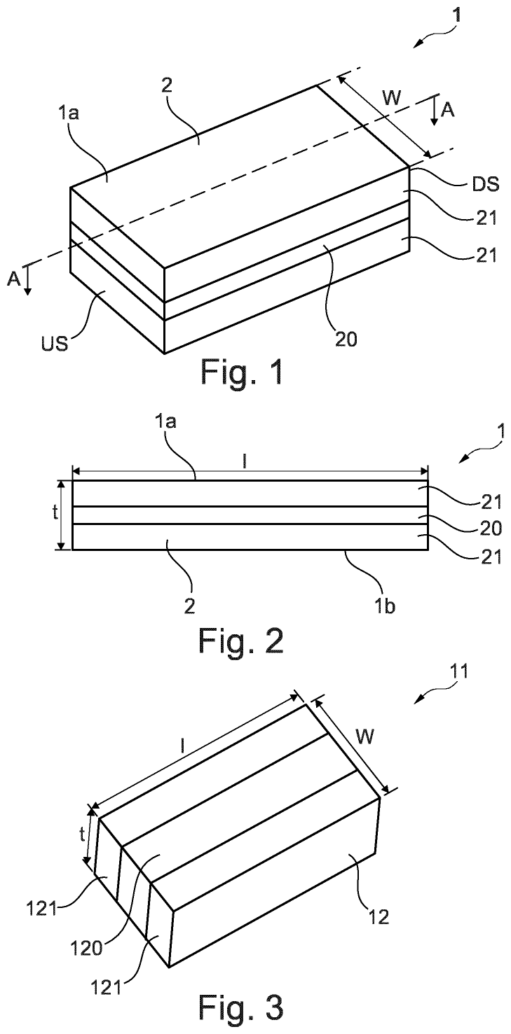

FIG. 1 is a schematic perspective view of an article for forming an aerosol according to an embodiment of the invention;

FIG. 2 is a schematic cross-sectional view along line A-A of the article for forming an aerosol shown in FIG. 1;

FIG. 3 is a schematic perspective view of an article for forming an aerosol according to a further embodiment of the invention;

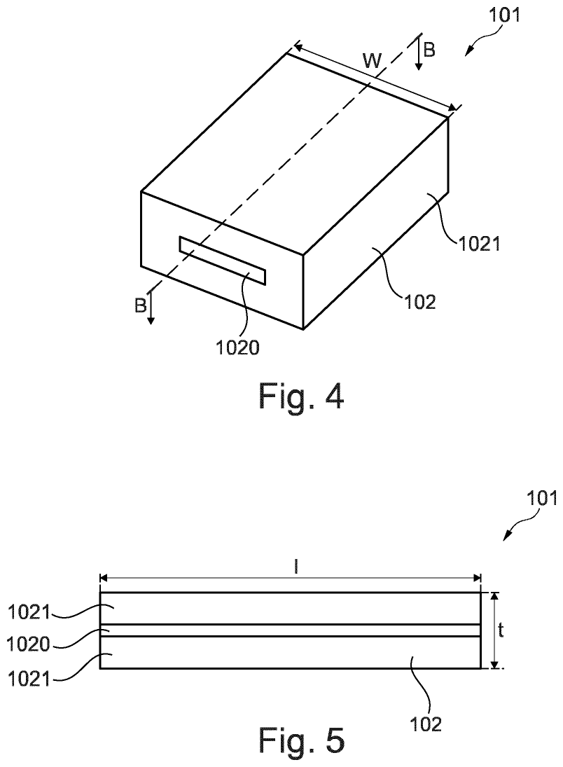

FIG. 4 is a schematic perspective view of an article for forming an aerosol according to a further embodiment of the invention; and

FIG. 5 is a schematic cross-sectional view along line B-B of the article for forming an aerosol shown in FIG. 4;

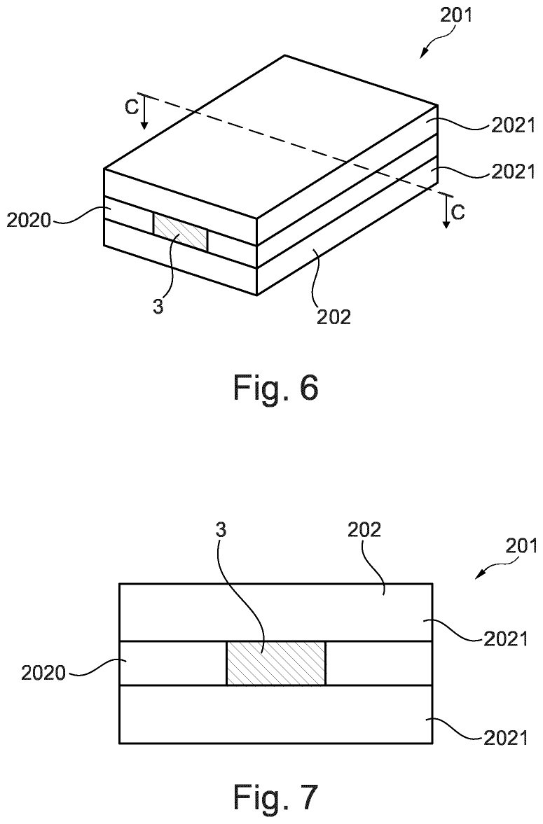

FIG. 6 is a schematic perspective view of an article for forming an aerosol according to a further embodiment of the invention; and

FIG. 7 is a schematic cross-sectional view along line C-C of the article for forming an aerosol shown in FIG. 6.

Referring now to FIGS. 1 and 2, there is shown an article 1 for forming an aerosol according to an embodiment of the invention. The article 1 comprises an aerosol-forming substrate 2 having first and second regions 20, 21. The first region 20 is sandwiched by the second region 21 in this embodiment.

The article 1 has first and second major surfaces 1a, 1b which are substantially flat, in this embodiment. In embodiments, however, the article 1 may have only a first major surface 1a which is substantially flat. The first and second major surfaces 1a, 1b extend in parallel relations to one another, in this embodiment. The second region 21 is directly adjacent each of the first and second major surfaces 1a, 1b, with the first region 20 spaced therefrom.

The article 1 has a generally parallelepiped shape, in this embodiment. The article 1 has a width w, a length I and a thickness t. The first and second regions 20, 21 of the aerosol-forming substrate 2 each extend across both the width w and length I of the article 1. Neither of the first and second regions 20, 21, however, extend across the thickness t of the article 1. The article has a first, upstream end US and a second, downstream end DS, opposed to the upstream end US.

The first region 20 of the aerosol-forming substrate 2 has a relatively lower density than does the second region 21 of the aerosol-forming substrate 2, in this embodiment. Both first and second regions 20, 21 of the aerosol-forming substrate 2 are formed from reticulated open-celled foam, in this embodiment. However, in embodiments, the aerosol-forming substrate 2 may comprise a different structure. For example, the aerosol-forming substrate 2 may comprise a fluid, a solid or a fluid and a solid mixture. Where the aerosol-forming substrate 2 is a fluid it may be held or retained within a matrix, for example a carrier material. The carrier material may comprise a foam, such as a reticulated open-celled foam. Where the aerosol-forming substrate 2 is a solid it may comprise one or more of: powder, granules, pellets, shreds, strands, strips or sheets of aerosol-forming substrate 2. Solid aerosol-forming substrate 2 may be retained within a carrier material which may have a matrix structure (e.g. comprise a foam, such as a reticulated open-celled foam).

The aerosol-forming substrate comprises reconstituted tobacco, in this embodiment.

The article 1 optionally comprises a wrapper or cover layer (not shown) which circumscribes its outer surfaces. The optional wrapper or cover layer may be removed before use of the article 1 in a device for generating an aerosol (not shown). Alternatively, the optional wrapper or cover layer may be left covering the outer surfaces of the article 1 when it is inserted into a heating chamber of the device for generating an aerosol.

Aerosol-forming substrate 2 for forming the first region 20 may be formed separately from aerosol-forming substrate 2 for forming the second region 21. A casting process may be utilized. For example, aerosol-forming substrate for forming the first region 20 may be cast on a first moving belt (for example a first part of the moving belt) while aerosol-forming substrate for forming the second region 20 may be cast on a second moving belt (or on a second part of the first moving belt). The aerosol-forming substrate of the first region and second regions may be combined into the relations shown in FIGS. 1 and 2 using an extrusion process. Alternatively, the aerosol-forming substrate of the first and second regions may be combined into the relations shown in FIGS. 1 and 2 using a lamination technique. Where an extrusion process is used, an elongate strip of combined aerosol-forming substrate comprising regions corresponding to the first and second regions may be formed. This elongate strip may then be sequentially cut or otherwise severed at desired locations along its length in order to form the required length of individual articles 1 for forming an aerosol.

Where an optional wrapper or cover layer is provided this may be wrapped about the first and second regions 20, 21 of aerosol-forming substrate 2 prior to or subsequent to cutting into the required length of an article 1 for forming an aerosol.

Alternatively, the first and/or second region 20, 21 of aerosol-forming substrate 2 may be moulded into its desired size and/or shape. For example, the second region 21 may be formed first (for example via moulding) with the first region 20 then moulded thereonto. In embodiments, where a wrapper or cover layer is provided the first and/or second region 20, 21 may be moulded in the wrapper or cover layer. In embodiments, the first and second regions 20, 21 may be manufactured using different techniques (for example one region 20, 21 may be formed by extrusion whilst the other region 20, 21 may be formed by moulding).

In use, a user inserts an article 1 for forming an aerosol into a heating chamber of a device for generating an aerosol. The article 1 is heated in the heating chamber such that volatile compounds are released in a vapour form from the aerosol-forming substrate 2. Air is drawn (for example by the user drawing on a mouthpiece of the device or, optionally, a filter or mouthpiece end of the article 1) through and/or past the article 1. The vapour of volatile compounds are entrained in the air flow and are caused or allowed to cool, whereupon the vapour condenses to form an aerosol. The aerosol may then be inhaled by the user of the device for generating an aerosol.

Advantageously, the non-round cross-sectional shape of the article 1 provides relatively enhanced efficiency of aerosol-formation than is achieved with prior art articles for forming an aerosol (which typically have a round cross-section, as explained above). A parallelepiped shaped article 1 is particularly advantageous in this respect. For a given volume a parallelepiped shape has a greater surface area to volume ratio than does a cylinder or a sphere. Accordingly, thermal energy may be transferred more readily into all parts of the parallelepiped shaped article 1 than is achievable using a prior art article for forming an aerosol having a cylindrical shape. Furthermore, due to the relatively increased surface area to volume ratio of the parallelepiped shaped article 1 versus prior art articles for forming a substrate having a cylindrical shape, volatile compounds may be extracted from the article with relatively greater ease.

Furthermore, due to the relatively lower density of the first region 20 with respect to the density of the second region 21, the porosity of the first region 20 may be relatively greater than is the porosity of the second region 21. Accordingly, the flow of air through the article 1 (where air flows therethrough, in use), from the upstream end US to the downstream end US of the article 1, may encounter relatively reduced resistance in the first region 20 than in the second region 21, and therefore may be relatively faster in the first region 20 than in the second region 21. The pressure in the first region 20 may therefore be lower than the pressure in the second region 21, thereby acting to draw volatilized compounds from the second region 21 into the air flow through the first region 20 (and hence enhancing egress of such volatilized compounds from the article 1).

Additionally, provision of regions 20, 21 of aerosol-forming substrate 2 having different densities allows the provision of relatively greater density in a second region 21, which may be configured to be adjacent a heating element of a device for generating an aerosol, in use, whist maintaining a desired average resistance to draw of the article 1, as a whole (through provision of a lower density first region 20).

In some embodiments, the first and/or second region 20, 21 may be at least partially resilient (for example may comprise a resilient material). Provision of a relatively less dense first region 20 may provide the first region 20 with relatively greater resiliency than that of the relatively denser second region 21. The article 1 may be shaped and/or sized to at least slightly exceed the size and/or shape of a heating chamber of a device for generating an aerosol into which it is intended to be inserted, in use. Accordingly, insertion of the article 1 into the heating chamber of the device may at least partially compress the article 1. Advantageously, resiliency of the first and/or second region 20, 21 may enhance the intimacy of contact of the first and/or second major surface 1a, 1b of the article 1 with heating surfaces of the heating chamber of the device for generating an aerosol. Transfer of thermal energy into the article 1 may, thereby, be relatively enhanced. Provision of a relatively denser second region 21 may provide a desired mass of aerosol-forming substrate (for example adjacent heating surfaces of the heating chamber into which the article is inserted), whilst provision of the relatively less dense first region 20 may more effectively resiliently bias the article into intimate contact with the heating surfaces of a heating chamber, within which it is inserted, to thereby allow more efficient heating of the mass of aerosol-forming substrate in the article 1.

Referring now to FIG. 3, there is shown an article 11 for forming an aerosol according to a further embodiment of the invention, wherein like features to those described in respect of the article 1 shown in FIGS. 1 and 2 are designated by like references preceded by a ‘1’ and will not be described further herein. In this embodiment, the first and second regions 120, 121 of the aerosol-forming substrate 12 each extend across both the thickness t and the length I of the article. However, neither the first nor the second regions 120, 121 extend across the width w of the article 1.

Referring now to FIGS. 4 and 5, there is shown an article 101 for forming an aerosol according to a further embodiment of the invention, wherein like features to those described in respect of the article 1 shown in FIGS. 1 and 2 are designated by like references preceded by a ‘10’ and will not be described further herein. In this embodiment, the first and second regions 1020, 1021 of the aerosol-forming substrate 102 each extend across the length I of the article 101. The first region 1020 does not extend across the width w or the thickness t of the article 101. The second region 1021 extends across the width w and the thickness t of the article 101, in regions of the article 101 absent the first region 1020.

Referring now to FIGS. 6 and 7, there is shown an article 201 for forming an aerosol according to a further embodiment of the invention, wherein like features to those described in respect of the article 1 shown in FIGS. 1 and 2 are designated by like references preceded by a ‘20’ and will not be described further herein. The article 201 comprises an optional metallic element 3 located in the first region 2020 of the aerosol-forming substrate 202. The optional metallic element 3 extends along the length I of the article 201 but not across the thickness t or the width w of the article 201, in this embodiment. In use, the optional metallic element 3 may be inductively heated by an inductive coil of a device for generating an aerosol. The metallic element 3 may be formed from any suitable metal which generates heat when subjected to a magnetic field.

While the article 1, 11, 101, 201 is shown as generally parallelepiped in shape this need not be the case and, instead, the article 1, 11, 101, 201 may have any suitable shape comprising a first major surface which is substantially flat. Additionally or alternatively, the relative densities of the regions 20, 21, 120, 121, 1020, 1021, 2020, 2021 of any of the articles 1, 11, 101, 201 may be reversed, in embodiments. Additionally or alternatively, the article 1, 11, 101, 201 may comprise more than two regions 20, 21, 120, 121, 1020, 1021, 2020, 2021, for example three, four or more regions of aerosol-forming substrate 2, 12, 102, 202. Where more than two regions 20, 21, 120, 121, 1020, 1021, 2020, 2021 are provided the further regions may have a similar density or a different density to that of the first or second region 20, 21, 120, 121, 1020, 1021, 2020, 2021 of aerosol-forming substrate 2, 12, 102, 202.

While the article 1, 11, 101, 201 is described as comprising aerosol-forming substrate 2, 12, 102, 202 comprising reconstituted tobacco this need not be the case and, instead, the aerosol-forming substrate 2, 12, 102, 202 may comprise any suitable material or mix of materials. For example, the aerosol-forming substrate 2, 12, 102, 202 may comprise tobacco which is not reconstituted. Additionally or alternatively, although the first and second regions 20, 21, 120, 121, 1020, 1021, 2020, 2021 of the aerosol-forming substrate 2, 12, 102, 202 are described as comprising the same material and the same structure in the articles 1, 11, 101, 201 this need not be the case and, instead, the first and second regions 20, 21, 120, 121, 1020, 1021, 2020, 2021 of aerosol-forming substrate 2, 12, 102, 202 may comprise different materials and/or may have a different structure (e.g. only one may be formed from a foam or a reticulated open-celled foam). Additionally or alternatively, the aerosol-forming substrate 2, 12, 102, 202 and/or the article 1, 11, 101, 201 may comprise one or more additives, for example a volatile flavour-generating component, an aerosol former, a flavourant, nicotine or the like.

Additionally or alternatively, although the metallic element 3 is described as being located in the first region 2020 of the aerosol-forming substrate 202 this need not be the case and, instead, the metallic element 3 may be located in the second region 2021 alone or in both the first and second regions 2020, 2021. Additionally or alternatively, although the metallic element 3 is described as extending along the length I of the article 201 this need not be the case and, instead, the metallic element 3 may have any suitable size and shape (for example relative to the article 201). Additionally or alternatively, although the metallic element 3 is shown as having the form of a strip this need not be the case and, instead, the metallic element 3 may comprise any suitable shape, for example a loop or coil. Additionally or alternatively, the metallic element 3 may comprise plural metallic elements 3. Where plural metallic elements 3 are provided they may have similar sizes and/or shapes or may have different sizes and/or shapes. Where plural metallic elements 3 are provided they may be uniformly or randomly distributed in the article 201, for example in one or more region 2020, 2021 of the aerosol forming substrate 202. Additionally or alternatively, while a metallic element 3 has been described only in respect of the article 201 shown in FIGS. 6 and 7, it will be appreciated that any embodiment of the invention may comprise a metallic element 3 (which may have any of the above-described features or characteristics).

The schematic drawings are not necessarily to scale and are presented for purposes of illustration and not limitation. The drawings depict one or more aspects described in this disclosure. However, it will be understood that other aspects not depicted in the drawings fall within the scope of this disclosure.

1. An article for forming an aerosol, the article comprising an aerosol-forming substrate and a first major surface which is substantially flat, the aerosol-forming substrate formed from an aerosol-forming material comprising a first region having a first density and a second region having a second density, where the first density is different to the second density, the article being insertable into the heating chamber of a device for generating an aerosol.

2. Article according to claim 1, wherein the article comprises a second major surface which is substantially flat.

3. Article according to claim 2, wherein the first and second major surfaces are substantially parallel to one another.

4. Article according to claim 3, wherein the first and second major surfaces are spaced from one another by less than 5 mm.

5. Article according to claim 1, wherein the article has a generally parallelepiped shape.

6. Article according to claim 1, wherein the first region is at least partially surrounded by the second region.

7. Article according to claim 1, wherein the first region is at or adjacent one or more peripheral zones of the article.

8. Article according to claim 1, wherein the first region is sandwiched by the second region.

9. Article according to claim 1, wherein at least part of the article is formed of foam.

10. Article according to claim 9, wherein the foam is an open-celled foam.

11. Article according to claim 9, wherein the foam is a reticulated open-celled foam.

12. Article according to claim 9, wherein the aerosol-forming substrate comprises the foam.

13. Article according to claim 1, wherein the aerosol-forming substrate comprises tobacco.

14. Article according to claim 1, wherein the article comprises one or more metal elements.

15. Method of using an article for forming an aerosol, the method comprising:
a) providing an article for forming an aerosol comprising an aerosol-forming substrate and having a first major surface which is substantially flat, the aerosol-forming substrate comprising a first region having a first density and a second region having a second density, the first density being different to the second density;
b) inserting the article into a heating chamber of a device for generating an aerosol;
c) irradiating the article in the heating chamber with electromagnetic radiation to generate aerosol from the aerosol-forming substrate; and
d) flowing air through the aerosol-forming substrate.
